(19) United States
(12) Patent Application Publication
(10) Pub. No.: US 2026/0239051 A1
(43) Pub. Date: Aug. 13, 2026

(54) SCHEDULING RESTRICTION FOR USER EQUIPMENT WITH MULTI-RECEPTION CAPABILITY

(71) Applicant: Apple Inc., Cupertino, CA (US)

(72) Inventors: Jie Cui, San Jose, CA (US); Chunxuan Ye, San Diego, CA (US); Dawei Zhang, Saratoga, CA (US); Hong He, San Jose, CA (US); Qiming Li, Beijing (CN); Xiang Chen, Campbell, CA (US); Yang Tang, San Jose, CA (US)

(21) Appl. No.: 19/156,457

(22) PCT Filed: Feb. 16, 2024
(86) PCT No.: PCT/US2024/016143

§ 371 Date: Aug. 14, 2025

Related U.S. Application Data
(60) Provisional application No. 63/446,131, filed on Feb. 16, 2023.

(51) Int. Cl. H04W 24/08; H04L 5/00; H04W 72/1273

(52) U.S. Cl. CPC H04W 24/08; H04L 5/0048; H04W 72/1273

(57) ABSTRACT

A method is provided. The method includes receiving, by a user equipment (UE) from a base station, a signal that configures the UE to perform a measurement. The method includes indicating, to the base station, that the UE has a scheduling restriction capability. The method includes determining one or more first beams corresponding to one or more measurement occasions, the one or more first beams associated with at least one of a plurality of antenna panels of the UE. The method includes determining a second beam for reception of a data signal or a control signal, the second beam associated with a first antenna panel of the plurality. The method includes determining, based on the second beam, whether the one or more first beams include one or more conflicting beams. The method includes applying a scheduling restriction according to a TCI in response to the determination of conflicting beams.

### CROSS REFERENCE TO RELATED APPLICATIONS

The present application claims priority of US Provisional Application No. 63/446,131, filed on Feb. 16, 2023, entitled “SCHEDULING RESTRICTION FOR USER EQUIPMENT WITH MULTI-RECEPTION CAPABILITY”, which is herein incorporated by reference in its entirety.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation (5G) New Radio (NR). The wireless communication networks facilitate mobile broadband service using technologies such as OFDM, multiple input multiple output (MIMO), advanced channel coding, massive MIMO, beamforming, and/or other features.

### SUMMARY

In accordance with one aspect of the present disclosure, a method to be performed by a user equipment (UE) is provided. The method includes receiving, from a base station, a signal that configures the UE to perform a measurement. The method includes indicating, to the base station, that the UE has a scheduling restriction capability. The method includes determining one or more first beams corresponding to one or more measurement occasions, wherein the one or more first beams are associated with at least one of a plurality of antenna panels of the UE. The method includes determining a second beam for reception of a data signal or a control signal, wherein the second beam is associated with a first antenna panel of the plurality. The method includes determining, based on the second beam, whether the one or more first beams include one or more conflicting beams. The method includes applying a scheduling restriction according to a transmission configuration indicator (TCI) in response to determining that the one or more first beams include one or more conflicting beams.

In some implementations, the method includes, in response to determining that the one or more first beams include one or more conflicting beams, indicating the scheduling restriction to the base station.

In some implementations, the measurement includes a Layer 3 (L3) measurement. The UE performs beam sweeping using the one or more first beams.

In some implementations, the one or more conflicting beams are associated with the first antenna panel.

In some implementations, applying the scheduling restriction includes at least one of: indicating, to the base station, one or more restricted measurement occasions that correspond to the one or more conflicting beams, indicating, to the base station, one or more non-restricted measurement occasions that do not correspond to the one or more conflicting beams, or indicating, to the base station, a ratio between (i) a number of the one or more restricted measurement occasions and (ii) a total number of the one or more measurement occasions.

In some implementations, the UE indicates, to the base station and before each one of the measurement occasions, whether that measurement occasion is restricted.

In some implementations, the measurement includes a Layer 1 (L1) measurement.

In some implementations, the one or more conflicting beams are associated with the first antenna panel, or an angular distance between (i) the one or more conflicting beams and (ii) the second beam is below a threshold.

In some implementations, the one or more conflicting beams are radially arranged within a rough beam, and an angular distance between the rough beam and the second beam is below a threshold.

In some implementations, applying the scheduling restriction includes disabling the reception of the data signal or the control signal at one or more restricted measurement occasions that correspond to the one or more conflicting beams.

In some implementations, the one or more measurement occasions are within a measurement period. Applying the scheduling restriction includes: determining that all of the one or more measurement occasions occur during a period of high priority data or control reception; and extending the measurement period by a ratio of (i) a number of the one or more conflicting beams over (ii) a total number of the one or more first beams.

In some implementations, the one or more measurement occasions are within a measurement period. Applying the scheduling restriction includes: determining that a subset of the one or more measurement occasions occur during a period of high priority data or control reception; performing the measurement at the subset of the one or more measurement occasions; and disabling the measurement outside the subset of the one or more measurement occasions.

In accordance with one aspect of the present disclosure, one or more processors are provided. The one or more processors are configured to execute instructions that cause a UE to perform the method described above.

In accordance with one aspect of the present disclosure, a method to be performed by a base station is provided. The method includes configuring a UE to perform measurement with one or more first beams corresponding to one or more measurement occasions, wherein the one or more first beams are associated with at least one of a plurality of antenna panels of the UE. The method includes configuring the UE with a second beam for reception of a data signal or a control signal, wherein the second beam is associated with a first one of the plurality of antenna panels. The method includes receiving, from the UE, an indication that the UE has a scheduling restriction capability. The method includes determining the scheduling restriction applied by the UE.

In some implementations, determining the scheduling restriction includes receiving from the UE, an indication that indicates whether the UE performs the scheduling restriction. The indication indicates at least one of: one or more restricted measurement occasions; one or more non-restricted measurement occasions; or a ratio of (i) a number of the one or more restricted measurement occasions over (ii) a total number of the one or more measurement occasions.

In some implementations, determining the scheduling restriction performed by the UE includes receiving, from the UE and before each one of the measurement occasions, an indication of whether that measurement occasion is restricted.

In some implementations, the base station determines the scheduling restriction based on whether (i) a beam for transmitting a measurement signal and (ii) a beam for transmitting the data signal or the control signal, are type-D quasi co-located to a same reference signal.

In some implementations, the base station determines the scheduling restriction based on whether an angular distance between (i) a beam for transmitting a measurement signal and (ii) a beam for transmitting the data signal or the control signal, is below a threshold.

In some implementations, the one or more first beams are radially arranged within a rough receiving beam for receiving a measurement signal by the UE. The rough receiving beam corresponds to a rough transmitting beam for transmitting the measurement signal by the base station. The base station determines the scheduling restriction based on whether (i) the rough transmitting beam and (ii) a beam for transmitting the data signal or the control signal, are type-D quasi co-located to a same reference signal.

In some implementations, the one or more first beams are radially arranged within a rough receiving beam for receiving a measurement signal by the UE. The rough receiving beam corresponds to a rough transmitting beam for transmitting the measurement signal by the base station. The base station determines the scheduling restriction based on whether an angular distance between (i) the rough transmitting beam and (ii) a beam for transmitting the data signal or the control signal, is below a threshold.

In some implementations, the method further includes scheduling a transmission of the data signal or the control signal regardless of the scheduling restriction.

The details of one or more implementations of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network, according to some implementations.

FIG. 2 illustrates an example scenario where a UE applies a scheduling restriction, according to some implementations.

FIGS. 3A and 3B each illustrate an example scenario where a UE applies a scheduling restriction, according to some implementations.

FIG. 4 illustrates a flowchart of an example method, according to some implementations.

FIG. 5 illustrates a flowchart of another example method, according to some implementations.

FIG. 6 illustrates an example UE, according to some implementations.

FIG. 7 illustrates an example access node, according to some implementations.

### DETAILED DESCRIPTION

A user device, such as a UE, uses one or more receiver (RX) chains (e.g., antenna panels) to receive wireless signals from other devices (e.g., base stations). The received signals can include two types: (i) measurement signals that enable a UE to determine the communication quality, and (ii) non-measurement signals, such as data or control signals, that the UE uses for other purposes. The wireless signals are transmitted and received via beams, which describe the spatial distribution of electromagnetic fields that carry the wireless signals.

The UE can perform measurement at different layers, such as Layer One (L1) and Layer Three (L3). Depending on the configuration, the measurement process sometimes involves beam sweeping. Assuming a UE has two antenna panels and each antenna panel supports beam sweeping with four beams, the UE can utilize its two antenna panels to perform beam sweeping involving eight beams, each corresponding to a measurement occasion. The reception of data or control signals typically involves only one beam without sweeping.

When a base station schedules communication with a UE, it is possible that the base station schedules the UE both to perform a measurement and to perform data or control signal reception at approximately the same time. This may lead to a scenario of conflict where the UE is unable to perform both types of communication as scheduled. For example, the beam for data or control signal reception (“data/control beam”) may be spatially too close to the beam(s) involved in the measurement (“measurement beams”), thereby potentially increasing the risk of interference between the data or control signals and the measurement signals. To resolve the conflict, the UE may choose to apply a scheduling restriction by performing one type of communication (e.g., measurement) while suspending the other type (e.g., data or control signal reception). However, this can increase communication latency and undermine communication stability.

Some UEs support simultaneously receiving signals using multiple RX panels in certain frequency ranges (FR), such as FR2. For these UEs, the conflict may occur at one antenna panel and not the other antenna panels. For example, assuming the data/control beam is associated with a first antenna panel of a UE, the UE may observe conflict only between the data/control beam and the measurement beams associated with the first antenna panel. For measurement beams associated with the other antenna panels of the same UE, there may be no conflict with the data/control beam and the measurement can proceed on the other antenna panels as scheduled. Because scheduling restriction is only partially applied in this scenario, in this case, the UE does not need to apply a scheduling restriction to all beams but can allow a part of the communication to proceed without interruption.

The capability to apply a partial scheduling restriction is desirable because it reduces the interruption on the communication and improves communication latency. To support this capability, the UE and the base station need to agree on, e.g., the conditions for applying scheduling restriction, the operations after applying scheduling restriction, and the signaling between the UE and the base station about the applied scheduling restriction. In existing systems, however, this capability is not supported.

This disclosure describes systems and methods for applying a partial scheduling restriction. As described in detail below, implementations of the disclosure provide mechanisms for the UE to determine the scheduling restriction in various scenarios. Implementations of the disclosure also provide mechanisms for the base station to determine the scheduling restriction applied by the UE. With the features described below, the efficiency and reliability of the communication between the UE and the base station is improved.

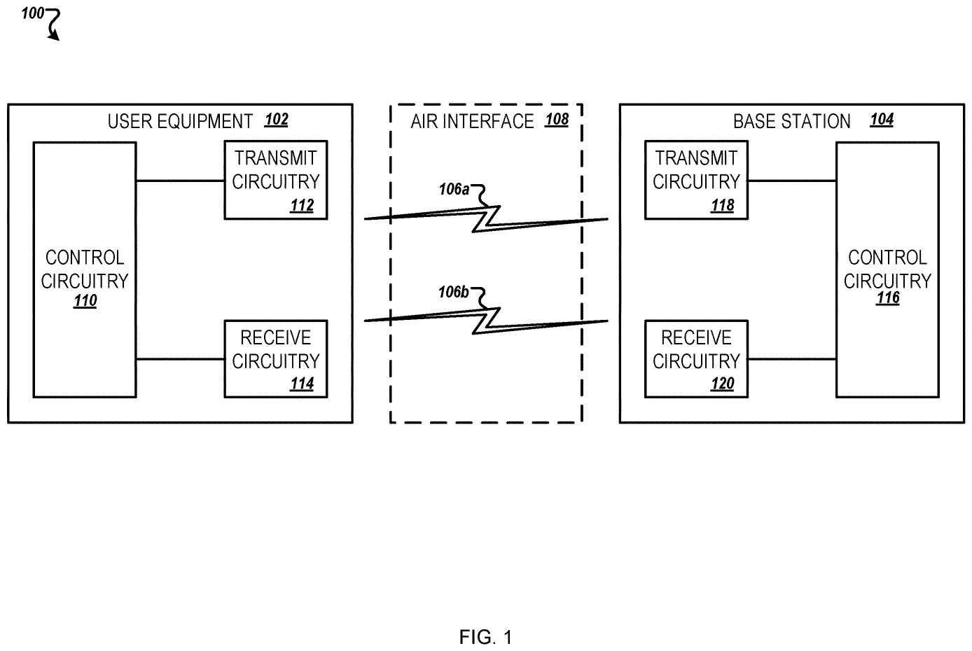

FIG. 1 illustrates an example wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates LTE and 5G NR communication standards as defined by the 3GPP technical specifications. For example, the wireless network 100 may be a E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE. For instance, the control circuitry 110 can control the transmit circuitry 112 and the receive circuitry 114 to exchange wireless signals, such as measurement signals or data or control signals, with the base station 104. The control circuitry 110 can also determine to apply scheduling restriction when applicable.

The transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

As an illustrative example of operations performed by various component circuitry of UE 102, the receive circuitry 114 may receive, from base station 104, a signal that configures UE 102 to perform a measurement, by including in the signal a measurement object indicating, e.g., whether the measurement is a L3 measurement or a L1 measurement, whether the measurement involves beam sweeping, and/or the measurement period. In response to receiving the signal, the transmit circuitry 112 may transmit a message to base station 104, indicating that UE 102 has a scheduling restriction capability, e.g., including whether UE 102 is capable of partially restricting measurement or data/control reception while keeping the other part uninterrupted. The control circuitry 110 can determine one or more first measurement beams corresponding to one or more measurement occasions, wherein the one or more first measurement beams are associated with at least one of a plurality of antenna panels of UE 102. The control circuitry 110 can further determine a second data/control beam for reception of a data signal or a control signal, wherein the second data/control beam is associated with a first antenna panel of the plurality of antenna panels. Based on the second data/control beam, the control circuitry 110 can determine whether the one or more first measurement beams comprise one or more conflicting beams. In response to determining that the one or more first measurement beams comprise one or more conflicting beams, the control circuitry 110 can apply a scheduling restriction according to a TCI.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

As an illustrative example of operations performed by various component circuitry of base station 104, transmit circuitry 118 can transmit a signal to UE 102 to configure the UE to perform measurement with one or more first measurement beams corresponding to one or more measurement occasions, wherein the one or more first beams are associated with at least one of a plurality of antenna panels of the UE. The transmit circuitry 118 can also send further instructions to configure UE 102 with a second data/control beam for reception of a data signal or a control signal, wherein the second data/control beam is associated with a first antenna panel of the plurality of antenna panels. The receive circuitry 120 can receive, from UE 102, an indication that the UE has a scheduling restriction capability, including whether the UE is capable of partially restricting measurement or data/control reception while keeping the other part uninterrupted. The control circuitry 116 can determine the scheduling restriction performed by UE 102. The control circuitry 116 can make the determination based on receiving the indication from UE 102 about its scheduling restriction capability, or can be based on the base station's inference.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

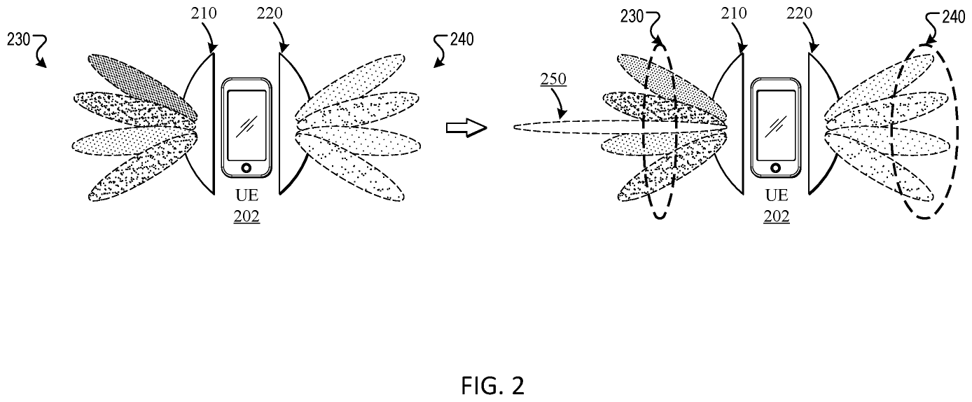

FIG. 2 illustrates an example scenario 200 where UE 202 applies a scheduling restriction, according to some implementations. Scenario 200 can occur when UE 202 performs L3 measurement with beam sweeping. UE 202 can be similar to UE 102 of FIG. 1.

As shown in FIG. 2, UE 202 has two antenna panels 210 and 220. Each of antenna panels 210 and 220 supports measurement beam sweeping with four beams. That is, antenna panel 210 supports beam sweeping with four beams, collectively referred to as measurement beams 230. Likewise, antenna panel 220 supports beam sweeping with four beams, collectively referred to as measurement beams 240. Measurement beams 230 and 240 together correspond to eight measurement occasions when UE 202 can receive a measurement signal from a base station (e.g., base station 104 of FIG. 1).

The base station can transmit a TCI to UE 202 to schedule UE 202 for data or control signal reception. The TCI can specify the antenna panel of the data/control beam, as well as the time and duration of the data or control signal reception. In scenario 200, UE 202 is scheduled to perform data or control signal reception using data/control beam 250 associated with antenna panel 210. As described earlier, the same antenna panel 210 is associated with measurement beams 230.

In this case, a conflict can arise between the data or control signal reception and the measurement. For example, UE 202 may not support using the same antenna panel 210 to both perform a L3 measurement and receive data or control signals at (approximately) the same time. As a result, UE 202 can apply a scheduling restriction by disabling data or control signal reception at the measurement occasions corresponding to measurement beams 230. Measurement beams 230 in this case are considered conflicting beams, and their corresponding measurement occasions are considered restricted measurement occasions. Because measurement beams 240 are associated with antenna panel 220, which is different from antenna panel 210, no conflict exists between measurement beams 240 and data/control beam 250. Therefore, UE 202 can receive data or control signals using beam 250 at the same time when UE 202 performs measurement beam sweeping using measurement beams 240. Measurement beams 240 in this case are considered non-conflicting beams, and their corresponding measurement occasions are considered non-restricted measurement occasions Keeping with scenario 200, UE 202 can indicate its scheduling restriction capability to the base station that schedules the measurement and the data or control signal reception. UE 202 can also indicate to the base station how the scheduling restriction is applied. For example, UE 202 can indicate all of the restricted measurement occasions to the base station. Alternatively or additionally, UE 202 can indicate all of the non-restricted measurement occasions to the base station. Alternatively or additionally, UE 202 can indicate a ratio between (i) the number of restricted measurement occasions and (ii) the total number of measurement occasions, to the base station (e.g., 4/8=0.5 in scenario 200). Alternatively or additionally, before each the eight measurement occasions, UE 202 can dynamically indicate to the base station whether that measurement occasion is restricted.

In the description with reference to scenario 200, the applied scheduling restriction is to disable the data or control signal reception at the restricted measurement occasions. This approach prioritizes L3 measurement signal reception over data or control signal reception. In some implementations, the UE can apply a scheduling restriction following a different approach by, e.g., prioritizing the data or control signal reception over L3 measurement signal reception. As a first example, when the data or control signal has high priority, the UE can keep the data or control signal reception uninterrupted while disabling the measurement beam sweeping at the restricted measurement occasions. The UE can extend the measurement period to compensate for the disabled measurement occasions. For example, when four out of eight measurement occasions are restricted and all four restricted measurement occasions coincide with the data or control signal reception, the UE disables measurement at the four restricted measurement occasions. To compensate for the four disabled measurement occasions, the UE can extend the measurement period by (4/8) times the original measurement period, resulting in a 50% increase of the measurement period.

As a second example of prioritizing the data or control signal reception over L3 measurement signal reception, when high priority data or control signal reception coincide with a subset of the restricted measurement occasions, the UE can keep the data or control signal reception uninterrupted while performing the measurement only at the measurement occasions that do not coincide with the data or control signal reception. As such, the UE does not extend the measurement period but performs measurement at a reduced number of occasions. For example, when two out of four restricted measurement occasions coincide with high priority data or control signal reception, the UE can perform measurement only at the other two occasions that do not coincide with the data or control signal reception.

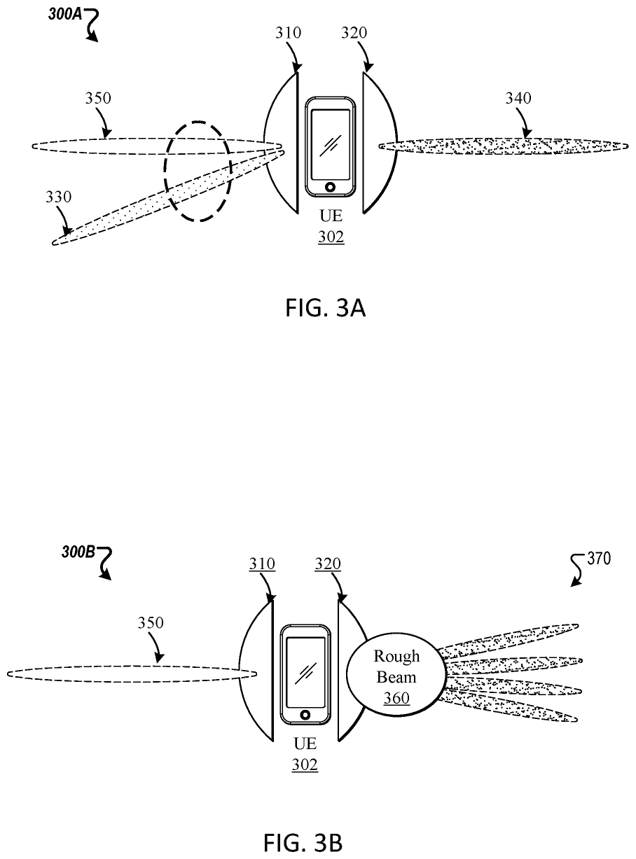

FIGS. 3A and 3B each illustrate an example scenario, 300A and 300B respectively, where UE 302 applies a scheduling restriction, according to some implementations. Scenarios 300A and 300B can occur when UE 302 performs L1 measurement, such as L1 reference signal received power (L1-RSRP), L1 signal to interference and noise ratio (L1-SINR), radio link monitoring (RLM), bidirectional forwarding detection (BFD), and candidate beam detection (CBD). UE 302, which has antenna panels 310 and 320, can be similar to UE 102 of FIG. 1 or UE 202 of FIG. 2.

Starting with scenario 300A, UE 302 does not perform measurement beam sweeping in scenario 300A. Instead, UE 302 is configured to simultaneously have measurement beam 330 associated with antenna panel 310 and measurement beam 340 associated with antenna panel 320. In addition, UE 302 is configured, via a TCI from the base station, to perform data or control signal reception using data/control beam 350 associated with antenna panel 310.

A conflict can arise between the data or control signal reception and the measurement. Similar to L3 measurement described with reference to scenario 200, measurement beam 330 and data/control beam 350 can conflict because the two beams are both associated with the same antenna panel 310. In addition, conflict can occur in the L1 measurement if the angular distance between a measurement beam and a data/control beam is below a threshold (which means the two beams are too close to receive signals). In some implementations, the threshold is represented as an angle of departure (AoD) and is predefined by UE 302 or the base station.

Assuming the angular distance between data/control beam 350 and measurement beam 340 is greater than the threshold, data/control beam 350 only has a conflict with measurement beam 330. As a result, UE 302 can apply a scheduling restriction by disabling data or control signal reception at the measurement occasion corresponding to measurement beams 330. In this case, measurement beams 330 is considered a conflicting beam, and its corresponding measurement occasion is considered a restricted measurement occasion. On the other hand, measurement beams 340 is considered a non-conflicting beam, and its corresponding measurement occasion is considered a non-restricted measurement occasion.

Moving to scenario 300B, UE 302 in scenario 300B can perform beam sweeping for L1 measurement. The measurement beams, collectively referred to as measurement beams 370, are associated with antenna panel 320. On the other hand, UE 302 is configured to perform data or control signal reception using data/control beam 350 associated with antenna panel 310.

UE 302 in scenario 300B is also configured with rough beam 360 associated with antenna panel 320. The term “rough beam,” as opposed to “fine beam,” means the beam has relatively low directivity and relatively broad radial coverage. As illustrated in FIG. 3B, rough beam 360 has broader radial coverage than each and all of measurement beams 370, which are radially arranged within rough beam 360. As such, while UE 302 performs L1 beam sweeping among measurement beams 370, the beam sweeping is radially bound by rough beam 360. In some implementations, UE 302 determines rough beam 360 by selecting the strongest beam from L3 beam sweeping, and then performs L1 beam sweeping among measurement beams 370 within the radial coverage of rough beam 360. An example of rough beam 360 is a beam for receiving a synchronization signal block (SSB).

Although data/control beam 350 is associated with a different antenna panel than that associated with measurement beams 370, a conflict between data/control beam 350 and measurement beams 370 still exist if the angular distance between data/control beam 350 and measurement beams 370 is below a threshold. Because measurement beams 370 are bound by rough beam 360 for the purpose of L1 beam sweeping, UE 302 can determine a conflict exists if the angular distance between data/control beam 350 and rough beam 360 is below the threshold. With this determination, UE 302 can apply a scheduling restriction by disabling data or control signal reception at the measurement occasions corresponding to measurement beams 370. In this case, measurement beams 370 are considered conflicting beams, and the corresponding measurement occasions are considered restricted measurement occasions.

UE 302 in scenarios 300A and 300B can indicate its scheduling restriction capability to the base station. UE 302 can also indicate to the base station how the scheduling restriction is applied. These indications can be similar to those described above with reference to scenario 200. For brevity, description of these indications is omitted.

In some implementations, the base station can determine that the scheduling restriction is applied to the L1 measurement without express indications from the UE. The determination can be based on an inference of conflict from quasi co-location (QCL) of transmission beams or from an angular distance between transmission beams. For example, the base station can determine whether (a) the beam(s) for transmitting a measurement signal (e.g., the measurement signal received by the UE using the measurement beam(s)) and (b) a beam for transmitting the data or control signal (e.g., the data or control signal received by the UE using the data/control beam) are type-D quasi co-located (QCL-TypeD) with the same reference signal. If the answer is Yes, the base station can infer that a conflict exists between the reception beams corresponding to (a) and (b). As another example, the base station can determine whether an angular distance between (a) and (b) is below a threshold. If Yes, the base station can also infer that a conflict exists between the two reception beams corresponding to (a) and (b). With the inference of conflict, the base station can further infer that the UE applies scheduling restriction as a result of the conflict. In scenario 300B and the like where the reception measurement beams are bound by a rough reception beam, the base station can use a corresponding rough transmission beam, such as a beam for transmitting a L3 reference signal, to make the inference.

Conversely, in some implementations, the base station can infer that the scheduling restriction is not applied during the L1 measurement (e.g., the scheduling restriction is “none” or “not applicable”). The base station can make the inference when the UE reports group-based L1 measurement results (e.g., L1 measurement results based on two reference signals, RS1 and RS2). For example, if a target L1 measurement reference signal TCI and a data or control signal TCI are quasi co-located (QCLed) with RS1 and RS2, respectively, the base station can infer that the scheduling restriction is not applied during the LI measurement. As such, the data or control signal which is QCLed with RS2 can be scheduled to in parallel with the target L1 measurement whose reference signal is QCLed with RS1. Alternatively or additionally, if a first target L1 measurement reference signal TCI and a second target L1 measurement reference signal TCI are QCLed with RS1 and RS2, respectively, the base station can infer that the scheduling restriction is not applied during the L1 measurement between the first target L1 measurement and the second target L1 measurement. As such, the UE can be scheduled to perform the first target L1 measurement and the second target L1 measurement simultaneously. For example, in some implementations, a UE, such as UE 302, can be configured to receive two data or control signal transmission occasions (e.g., Physical Downlink Shared Channel, PDSCH) from two different QCL sources on the primary cell (PCell). In such implementations, there are no scheduling restrictions for the two data or control signal transmission occasions due to beam failure detection performed based on the reference signals (e.g., Channel State Information Reference Signal, CSI-RS), when following conditions are met:
The CSI-RS is not in a CSI-RS resource set with repetition ON,
The CSI-RS has same QCL source as the active TCI state of one of the PDSCHs and has different QCL-TypeD from the other PDSCH,
The CSI-RS and both of the PDSCHs are on the same OFDM symbol(s), or the CSI-RS and only one of the PDSCHs with different QCL-TypeD are on the same OFDM symbol(s),
Resources of the active TCI states for the two PDSCHs have been reported as a resource group in a group-based RSRP report.

In some implementations, the base station can ignore the scheduling restriction applied by the UE. For example, in scenarios involving a L3 measurement, the base station can calculate a ratio by dividing (i) the number of symbols of a reference signal for L3 measurement plus a margin by (ii) a periodicity of the reference signal measured in number of symbols. If the ratio is less than a threshold (e.g., 0.5%), then the base station can infer that the density of L3 measurement symbols in each reference signal period is too low to justify scheduling restriction. The base station can thus schedule the data or control signal on any symbols regardless of the L3 measurement symbols and allow UE to experience interruption when receiving data or control signals on some L3 measurement symbols.

While the scheduling restrictions described with reference to scenarios 300A and 300B prioritize L1 measurement signal reception over data or control signal reception, a UE can instead apply a scheduling restriction that prioritizes data or control signal reception over L1 measurement signal reception. For example, the UE can either disable L1 measurement at restricted occasions and extend the measurement period, or perform L1 measurement only at restricted measurement occasions that do not coincide with the data or control signal reception. These scheduling restrictions on L1 measurement are similar to those described above on L3 measurement. For brevity, description of these scheduling restrictions on L1 measurement is omitted.

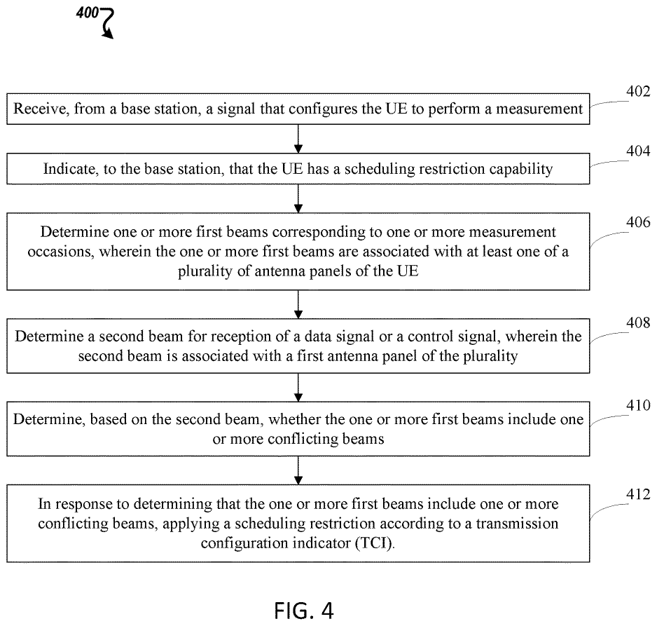

FIG. 4 illustrates a flowchart of an example method 400, according to some implementations. For clarity of presentation, the description that follows generally describes method 400 in the context of the other figures in this description. For example, method 400 can be performed by UEs 102, 202, or 302 of FIGS. 1-3B. It will be understood that method 400 can be performed, for example, by any suitable system, environment, software, hardware, or a combination of systems, environments, software, and hardware, as appropriate. In some implementations, various steps of method 400 can be run in parallel, in combination, in loops, or in any order.

At 402, method 400 involves receiving, from a base station, a signal that configures the UE to perform a measurement. In the signal, the base station can provide the UE with a measurement object about, e.g., whether the measurement is a L3 measurement or a L1 measurement, whether the measurement involves beam sweeping, and/or the measurement period.

At 404, method 400 involves indicating, to the base station, that the UE has a scheduling restriction capability. The indicated scheduling restriction capability can particularly include whether the UE is capable of partially restricting measurement or data/control reception while keeping the other part uninterrupted.

At 406, method 400 involves determining one or more first beams corresponding to one or more measurement occasions, wherein the one or more first beams are associated with at least one of a plurality of antenna panels of the UE. The one or more first beams can be similar to measurement beams 230 and 240 in FIG. 2, measurement beam 330 and 340 in FIG. 3A, or measurement beams 370 in FIG. 3B.

At 408, method 400 involves determining a second beam for reception of a data signal or a control signal, wherein the second beam is associated with a first antenna panel of the plurality. The second beam can be similar to data/control beam 250 in FIG. 2 or data/control beam 350 in FIGS. 3A and 3B.

At 410, method 400 involves determining, based on the second beam, whether the one or more first beams comprise one or more conflicting beams. The determination of conflicting beams can be similar to any of those described with reference to scenarios 200, 300A, and 300B.

At 412, method 400 involves applying a scheduling restriction according to a TCI in response to determining that the one or more first beams comprise one or more conflicting beams. The application of the scheduling restriction can be similar to any of those described with reference to scenarios 200, 300A, and 300B.

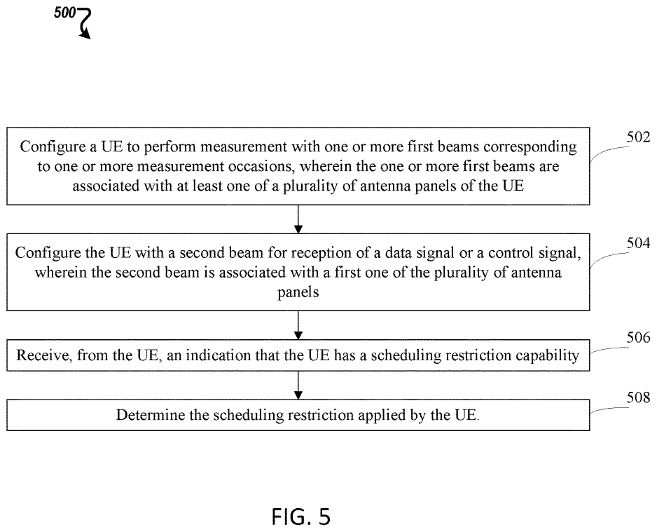

FIG. 5 illustrates a flowchart of an example method 500, according to some implementations. For clarity of presentation, the description that follows generally describes method 500 in the context of the other figures in this description. For example, method 500 can be performed by base station 104 of FIG. 1. It will be understood that method 500 can be performed, for example, by any suitable system, environment, software, hardware, or a combination of systems, environments, software, and hardware, as appropriate. In some implementations, various steps of method 500 can be run in parallel, in combination, in loops, or in any order.

At 502, method 500 involves configuring a UE to perform measurement with one or more first beams corresponding to one or more measurement occasions, wherein the one or more first beams are associated with at least one of a plurality of antenna panels of the UE. The one or more first beams can be similar to measurement beams 230 and 240 in FIG. 2, measurement beam 330 and 340 in FIG. 3A, or measurement beams 370 in FIG. 3B.

At 504, method 500 involves configuring the UE with a second beam for reception of a data signal or a control signal, wherein the second beam is associated with a first one of the plurality of antenna panels. The second beam can be similar to data/control beam 250 in FIG. 2 or data/control beam 350 in FIGS. 3A and 3B.

At 506, method 500 involves receiving, from the UE, an indication that the UE has a scheduling restriction capability. The indicated scheduling restriction capability can particularly include whether the UE is capable of partially restricting measurement or data/control reception while keeping the other part uninterrupted.

At 508, method 500 involves determining the scheduling restriction performed by the UE. The determination can be based on an indication from the UE, or can be based on the base station's inference.

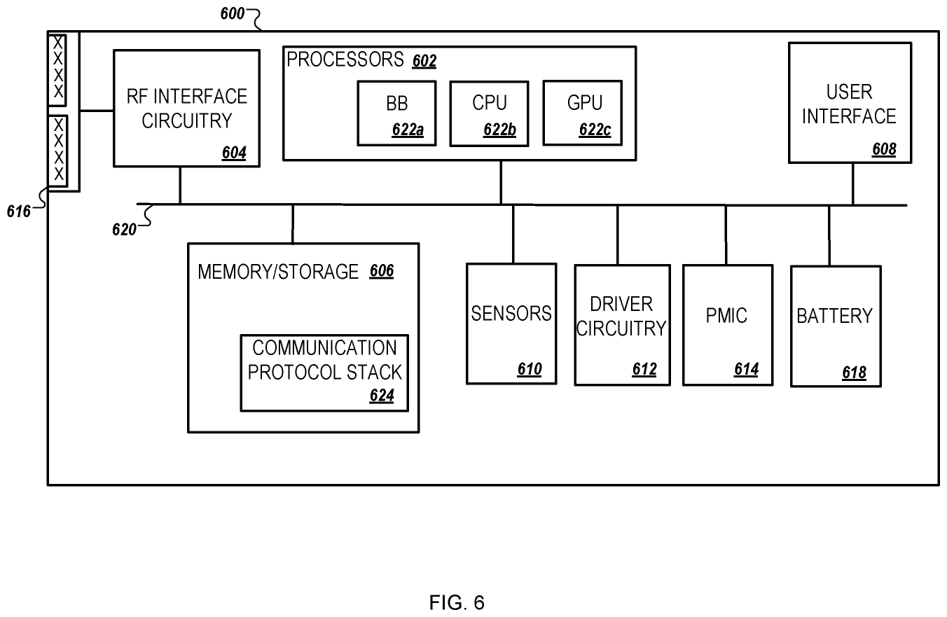

FIG. 6 illustrates an example UE 600, according to some implementations. The UE 600 may be similar to and substantially interchangeable with UE 102 of FIG. 1.

The UE 600 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 600 may include processors 602, RF interface circuitry 604, memory/storage 606, user interface 608, sensors 610, driver circuitry 612, power management integrated circuit (PMIC) 614, antenna structure 616, and battery 618. The components of the UE 600 may be implemented as integrated circuits (ICs), portions thereof, discrete electronic devices, or other modules, logic, hardware, software, firmware, or a combination thereof. The block diagram of FIG. 6 is intended to show a high-level view of some of the components of the UE 600. However, some of the components shown may be omitted, additional components may be present, and different arrangement of the components shown may occur in other implementations.

The components of the UE 600 may be coupled with various other components over one or more interconnects 620, which may represent any type of interface, input/output, bus (local, system, or expansion), transmission line, trace, optical connection, etc. that allows various circuit components (on common or different chips or chipsets) to interact with one another.

The processors 602 may include processor circuitry such as, for example, baseband processor circuitry (BB) 622A, central processor unit circuitry (CPU) 622B, and graphics processor unit circuitry (GPU) 622C. The processors 602 may include any type of circuitry or processor circuitry that executes or otherwise operates computer-executable instructions, such as program code, software modules, or functional processes from memory/storage 606 to cause the UE 600 to perform operations as described herein.

In some implementations, the baseband processor circuitry 622A may access a communication protocol stack 624 in the memory/storage 606 to communicate over a 3GPP compatible network. In general, the baseband processor circuitry 622A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 604. The baseband processor circuitry 622A may generate or process baseband signals or waveforms that carry information in 3GPP-compatible networks. In some implementations, the waveforms for NR may be based on cyclic prefix orthogonal frequency division multiplexing (OFDM) “CP-OFDM” in the uplink or downlink, and discrete Fourier transform spread OFDM “DFT-S-OFDM” in the uplink.

In some implementations, the RF interface circuitry 604 may receive, from a base station, a signal that configures UE 600 to perform a measurement, with the signal providing the UE with a measurement object, e.g., whether the measurement is a L3 measurement or a L1 measurement, whether the measurement involves beam sweeping, and/or the measurement period. The baseband processor circuitry 622A may obtain the signal from RF interface circuitry 604, and process the measurement object. The baseband processor circuitry 622A may generate a message for transmission to the base station, the message indicating that the UE has a scheduling restriction capability, including indicating whether the UE is capable of partially restricting measurement or data/control reception while keeping the other part uninterrupted. The baseband processor circuitry 622A may output the message to the RF interface circuitry 604 and instruct the RF interface circuitry 604 to transmit the message to the base station. The baseband processor circuitry 622A may determine one or more first beams corresponding to one or more measurement occasions, wherein the one or more first beams are associated with at least one of a plurality of antenna panels of UE 600. For example, the one or more first beams can be similar to measurement beams 230 and 240 in FIG. 2, measurement beam 330 and 340 in FIG. 3A, or measurement beams 370 in FIG. 3B. The baseband processor circuitry 622A may determine a second beam for reception of a data signal or a control signal, wherein the second beam is associated with a first antenna panel of the plurality of the antenna panels. For example, the second beam can be similar to data/control beam 250 in FIG. 2 or data/control beam 350 in FIGS. 3A and 3B. The baseband processor circuitry 622A may determine, based on the second beam, whether the one or more first beams comprise one or more conflicting beams, e.g., as described with reference to scenarios 200, 300A, and 300B. The baseband processor circuitry 622A may apply a scheduling restriction according to a TCI in response to determining that the one or more first beams comprise one or more conflicting beams. The application of the scheduling restriction can be similar to any of those described with reference to scenarios 200, 300A, and 300B. The baseband processor circuitry 622A may generate a message for the base station indicating the scheduling restriction, and instruct the RF interface circuitry 604 to send the message to the base station.

The memory/storage 606 may include one or more non-transitory, computer-readable media that includes instructions (for example, communication protocol stack 624) that may be executed by one or more of the processors 602 to cause the UE 600 to perform various operations described herein. The memory/storage 606 include any type of volatile or non-volatile memory that may be distributed throughout the UE 600. In some implementations, some of the memory/storage 606 may be located on the processors 602 themselves (for example, L1 and L2 cache), while other memory/storage 606 is external to the processors 602 but accessible thereto via a memory interface. The memory/storage 606 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 604 may include transceiver circuitry and radio frequency front module (RFEM) that allows the UE 600 to communicate with other devices over a radio access network. The RF interface circuitry 604 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 616 and proceed to filter and amplify (with a low-noise amplifier) the signal. The signal may be provided to a receiver of the transceiver that downconverts the RF signal into a baseband signal that is provided to the baseband processor of the processors 602.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 616. In various implementations, the RF interface circuitry 604 may be configured to transmit/receive signals in a manner compatible with NR access technologies.

The antenna 616 may include antenna elements to convert electrical signals into radio waves to travel through the air and to convert received radio waves into electrical signals. The antenna elements may be arranged into one or more antenna panels. The antenna 616 may have antenna panels that are omnidirectional, directional, or a combination thereof to enable beamforming and multiple input, multiple output communications. The antenna 616 may include microstrip antennas, printed antennas fabricated on the surface of one or more printed circuit boards, patch antennas, phased array antennas, etc. The antenna 616 may have one or more panels designed for specific frequency bands including bands in FR1 or FR2.

The user interface 608 includes various input/output (I/O) devices designed to enable user interaction with the UE 600. The user interface 608 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 600.

The sensors 610 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 612 may include software and hardware elements that operate to control particular devices that are embedded in the UE 600, attached to the UE 600, or otherwise communicatively coupled with the UE 600. The driver circuitry 612 may include individual drivers allowing other components to interact with or control various input/output (I/O) devices that may be present within, or connected to, the UE 600. For example, driver circuitry 612 may include a display driver to control and allow access to a display device, a touchscreen driver to control and allow access to a touchscreen interface, sensor drivers to obtain sensor readings of sensor circuitry 628 and control and allow access to sensor circuitry 628, drivers to obtain actuator positions of electro-mechanic components or control and allow access to the electro-mechanic components, a camera driver to control and allow access to an embedded image capture device, audio drivers to control and allow access to one or more audio devices.

The PMIC 614 may manage power provided to various components of the UE 600. In particular, with respect to the processors 602, the PMIC 614 may control power-source selection, voltage scaling, battery charging, or DC-to-DC conversion.

In some implementations, the PMIC 614 may control, or otherwise be part of, various power saving mechanisms of the UE 600. A battery 618 may power the UE 600, although in some examples the UE 600 may be mounted deployed in a fixed location, and may have a power supply coupled to an electrical grid. The battery 618 may be a lithium ion battery, a metal-air battery, such as a zinc-air battery, an aluminum-air battery, a lithium-air battery, and the like. In some implementations, such as in vehicle-based applications, the battery 618 may be a typical lead-acid automotive battery.

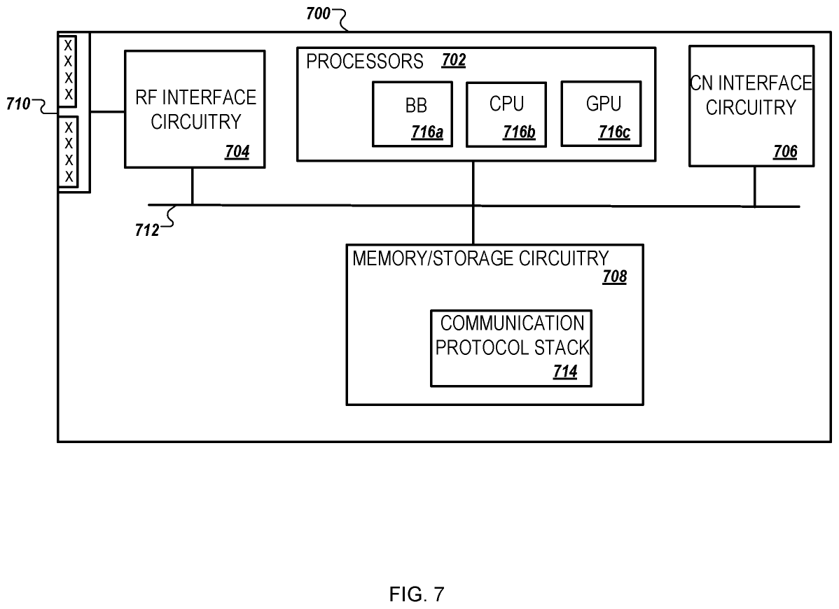

FIG. 7 illustrates an example access node 700 (e.g., a base station or gNB), according to some implementations. The access node 700 may be similar to and substantially interchangeable with base station 104. The access node 700 may include processors 702, RF interface circuitry 704, core network (CN) interface circuitry 706, memory/storage circuitry 708, and antenna structure 710.

The components of the access node 700 may be coupled with various other components over one or more interconnects 712. The processors 702, RF interface circuitry 704, memory/storage circuitry 708 (including communication protocol stack 714), antenna structure 710, and interconnects 712 may be similar to like-named elements shown and described with respect to FIG. 6. For example, the processors 702 may include processor circuitry such as, for example, baseband processor circuitry (BB) 716A, CPU 716B, and GPU 716C.

The CN interface circuitry 706 may provide connectivity to a core network, for example, a 5th Generation Core network (5GC) using a 5GC-compatible network interface protocol such as carrier Ethernet protocols, or some other suitable protocol. Network connectivity may be provided to/from the access node 700 via a fiber optic or wireless backhaul. The CN interface circuitry 706 may include one or more dedicated processors or FPGAs to communicate using one or more of the aforementioned protocols. In some implementations, the CN interface circuitry 706 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 700 that operates in an NR or 5G system (for example, a gNB), and the term “E-UTRAN node” or the like may refer to an access node 700 that operates in an LTE or 4G system (e.g., an eNB). According to various implementations, the access node 700 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 700 may be implemented as one or more software entities running on server computers as part of a virtual network, which may be referred to as a CRAN and/or a virtual baseband unit pool (vBBUP). In V2X scenarios, the access node 700 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more implementations, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-21. (canceled)

22. One or more processors configured to perform operations comprising:
determining, based on Layer-1 (L1) measurement information from a user equipment (UE), that a scheduling restriction is not applied during a target L1 measurement by the UE on a first beam; and
responsively scheduling, on a second beam, a downlink signal for the UE in parallel with the L1 measurement.

23. The one or more processors of claim 22, wherein the L1 measurement information comprises group-based L1 measurement results reported by the UE.

24. The one or more processors of claim 23, wherein the group-based L1 measurement results comprise measurements of a first reference signal (RS1) and a second reference signal (RS2).

25. The one or more processors of claim 24, wherein determining, based on the L1 measurement information, that the scheduling restriction is not applied during the target L1 measurement by the UE on a first beam comprises:
determining that a target L1 reference signal transmission configuration indicator (TCI) is quasi co-located with RS1 and a downlink signal TCI is quasi co-located with RS2.

26. The one or more processors of claim 22, wherein the determining comprises evaluating a relationship between (i) a transmission configuration indicator (TCI) associated with a target L1-measurement reference signal and (ii) a TCI associated with the downlink signal, the relationship indicating quasi-co-location (QCL).

27. The one or more processors of claim 26, wherein the evaluating comprises determining that the TCI associated with the target L1-measurement reference signal is quasi co-located with a first reference signal and the TCI associated with the downlink signal is quasi co-located with a second reference signal different from the first.

28. The one or more processors of claim 22, wherein the downlink signal comprises a physical downlink shared channel (PDSCH) transmission.

29. The one or more processors of claim 22, wherein the downlink signal comprises a physical downlink control channel (PDCCH) transmission.

30. The one or more processors of claim 22, wherein scheduling in parallel comprises allocating time resources for the downlink signal that at least partially overlap time resources used for the L1 measurement.

31. The one or more processors of claim 22, receiving, from the UE, a scheduling restriction capability.

32. One or more processors configured to perform operations comprising:
determining, based on Layer-1 (L1) measurement information, that a scheduling restriction is not applied during a target L1 measurement on a first beam associated with a first antenna panel of a user equipment (UE); and
in response, receiving, on a second beam associated with a second antenna panel of the UE, a downlink signal in parallel with a target reference signal for the target LI measurement.

33. The one or more processors of claim 32, the operations further comprising:
causing transmission of a scheduling restriction capability to the base station.

34. The one or more processors of claim 32, wherein the L1 measurement information comprises group-based L1 measurement results.

35. The one or more processors of claim 34, wherein the group-based L1 measurement results comprise measurements of a first reference signal (RS1) and a second reference signal (RS2).

36. The one or more processors of claim 35, wherein determining, based on the L1 measurement information, that the scheduling restriction is not applied during the target L1 measurement comprises:
determining that a transmission configuration indicator (TCI) of the target reference signal is quasi co-located with RS1 and a TCI of the downlink signal is quasi co-located with RS2.

37. The one or more processors of claim 32, wherein the determining comprises evaluating a relationship between (i) a transmission configuration indicator (TCI) associated with the target reference signal and (ii) a TCI associated with the downlink signal, the relationship indicating quasi-co-location (QCL).

38. The one or more processors of claim 37, wherein the evaluating comprises determining that the TCI associated with the target L1-measurement reference signal is quasi co-located with a first reference signal and the TCI associated with the downlink signal is quasi co-located with a second reference signal different from the first.

39. The one or more processors of claim 32, wherein scheduling in parallel comprises allocating time resources for the downlink signal that at least partially overlap time resources used for the L1 measurement.

40. A method comprising:
determining, based on Layer-1 (L1) measurement information, that a scheduling restriction is not applied during a target L1 measurement on a first beam associated with a first antenna panel of a user equipment (UE); and
in response, receiving, on a second beam associated with a second antenna panel of the UE, a downlink signal in parallel with a target reference signal for the target L1 measurement.

41. The method of claim 40, further comprising:
transmitting a scheduling restriction capability to the base station.
